(19) United States
(12) Patent Application Publication
(10) Pub. No.: US 2024/0147276 A1
(43) Pub. Date: May 2, 2024

(54) LINK FAILURE DETECTION FOR MULTI-LINK DEVICE

(71) Applicant: Hewlett Packard Enterprise Development LP, Spring, TX (US)

(72) Inventors: Xuguang JIA, Beijing (CN); Yongchang GUO, Beijing (CN); Zhenlei WANG, Beijing (CN)

(21) Appl. No.: 18/050,609

(22) Filed: Oct. 28, 2022

(51) Int. Cl. H04W 24/10; H04L 43/0811; H04W 24/04; H04W 52/02; H04W 76/19

(52) U.S. Cl. CPC H04W 24/10; H04L 43/0811; H04W 24/04; H04W 52/0229; H04W 76/19

(57) ABSTRACT

Implementations of the present disclosure relate to link failure detection. In the implementations, an access point (AP) determines a power save mode of each of a plurality of links established between the AP and a station. If at least two links of the plurality of links are in a power save mode, the AP determines a detection time period for detecting signals based on beacon intervals of the at least two links. The AP then transmits detection signals to the station in the at least two links during the detection time period. The AP determines connectivity of the at least two links based on responses to the detection signals received from the station. In this way, all the failed links in power save mode can be efficiently detected, thereby facilitating transmission scheduling between the AP and station.

### BACKGROUND

Some wireless networks, such as 802.11 be networks (also referred to as Extremely High Throughput (EHT) networks), allow devices to communicate via two or more communication links simultaneously, for example, using multi-link aggregation (MLA), and such devices may be referred to as multi-link devices (MLDs). Multi-link operation (MLO) is one major media access control (MAC) feature introduced in the 802.11be standard, and MLO enables a non-access point (AP) MLD to discover, authenticate, associate, and set up multiple links with an AP MLD. After the MLD setup procedure, each link enables channel access and frames exchanges between the non-AP MLD and the AP MLD. Through the MLO, access points and stations can be provided with the capabilities to transmit and receive data from the same traffic flow over multiple links.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures:

FIG. 1 illustrates a block diagram of an example MLD deployment in which example implementations of the present disclosure may be implemented;

FIGS. 2A-2C illustrate example flowcharts of link failure detection in accordance with some example implementations of the present disclosure;

FIGS. 3A-3B illustrate example procedures for beacon transmissions in accordance with some example implementations of the present disclosure;

FIGS. 4A-4B illustrate example procedures for link failure detections for multiple asleep links in accordance with some example implementations of the present disclosure;

FIG. 5 illustrates an example procedure for link failure detections for multiple awake links in accordance with some example implementations of the present disclosure;

FIGS. 6A-6B illustrate example procedures for link failure detections for awake and asleep links in accordance with some example implementations of the present disclosure; and

FIG. 7 illustrates a block diagram of an example AP MLD in accordance with some example implementations of the present disclosure.

### DETAILED DESCRIPTION

As discussed above, MLO can provide higher throughput and allow MLDs to achieve simultaneous transmission and reception via different links established between the AP MLD and non-AP MLD. The links are located on different channels or different bands. In addition, if one link is failed, the data can still be transmitted via other links. However, when all the links are failed, the AP MLD determines that it has lost connectivity with the non-AP MLD. In order to avoid recourse waste, the non-AP MLD should be disassociated from the AP MLD. In this regard, all the failed links must be detected quickly.

Conventionally, failed link disassociation mechanisms are provided for single link operations that allow the AP to disassociate the station (STA) when the AP has lost connectivity to the STA. For example, the AP will disassociate the STA when excessive transmission failures occur in a non-power save mode, which may also be referred to as non-power save mode, or when the maximum idle time is reached in sleep mode, and no feedback is received. However, due to the natural difference between the single link operation and the MLO, the conventional mechanisms could not be adapted for the MLO. For example, the conventional mechanisms may lead to wrong judgment for link failure detection in MLD and thus impact the airtime because data retransmissions flooded under these conditions. Further, the maximum idle time is usually very long. If the AP MLD disassociates the non-AP MLD only when the maximum idle time is reached, a certain amount of resources at the AP MLD will be wasted. Therefore, it is desirable for link failure detection mechanisms for the MLO.

Various example implementations of the present disclosure propose an efficient link failure detection scheme. Specifically, when two or more links established between an AP and a station are in power save mode, a common detection time period will be determined based on the beacon intervals of the two or more two links. During the detection time period, the entities in the station associated with two or more links are supposed to wake up and receive detection signals from the AP. After the detection time period is determined, the AP transmits detection signals in two or more links during the detection time period. The state of two or more links in the power save mode can be determined based on the responses.

With these implementations, instead of waiting for a maximum idle time of the links in the power save mode to determine whether a link is failed, the states of all the sleep links can be detected by transmitting detection signals in a common time period during which all the sleep links should wake up at least once. In this way, all the failed links in the power save mode can be efficiently detected, thereby facilitating transmission scheduling between the AP and station.

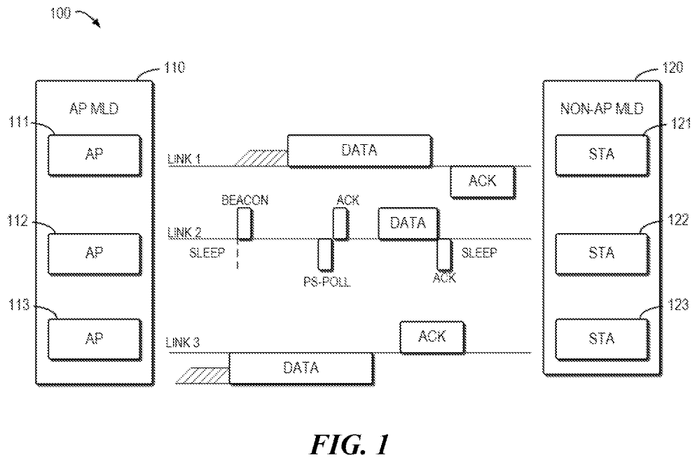

FIG. 1 illustrates a block diagram of an example MLD deployment 100 in which example implementations of the present disclosure may be implemented. As used herein, an AP MLD is a logical entity that contains one or more APs, and a non-AP MLD is a logical entity that contains one or more STAs. The logical entity has one MAC layer data service interface and primitives to the logical link control (LLC) and a single address associated with the interface, which may be used to communicate on the distribution system medium (DSM). A multi-link device allows STAs within the multi-link logical entity to have the same MAC address.

As illustrated in FIG. 1, an AP MLD 110 may communicate with a non-AP MLD 120. Each of the AP MLD 110 and the non-AP MLD 120 may include at least two STA entities (hereinafter also referred to simply as “STAs”) that may communicate with associated STAs of another MLD. In the AP MLD 110, the STAs may be AP STAs (STAs serving as APs or simply “APs”), including the AP 111, AP 112 and AP 113 in FIG. 1. In the non-AP MLD, the STAs may be non-AP STAs (STAs not serving as APs), including the STA 121, the STA 122 and the STA 123 in FIG. 1. The AP MLD 110 and non-AP MLD 120 may function and communicate according to the IEEE 802.11 family of wireless communication protocol standards, for example defined by the IEEE 802.11-2016 specification or amendments thereof including, but not limited to, 802.11ah, 802.11ad, 802.11ay, 802.11ax, 802.11az, 802.11ba, and 802.11be. These standards define the WLAN radio and baseband protocols for the physical (PHY) and MAC layers.

As illustrated in FIG. 1, a link 1 is established between the AP 111 and the STA 121, and the link 1 is in a non-power save mode. The AP 111 transmits data frames to the STA 121. Upon receiving the data frames transmitted by the AP 111, the STA 121 transmits an acknowledgment frame to the AP 111. As such, the data transmission between AP1 and STA 121 is completed.

A link 2 is established between the AP 112 and the STA 122, and the link 2 is in the power save mode, which may also be referred to as the sleep mode. In order to save power, the STA 122 will shut down some of the transceiver components for a period of time. The STA 122 may indicate that it is using power save mode by changing the value of the power management bit to “1” within the frame control field in a frame that is transmitted to the AP 112. For example, the transmitted frame indicating that the STA 122 is about to enter power save mode may be a null data frame. Once the AP 112 receives the indication from the STA 122, the AP 112 will buffer all unicast frames to the STA 122. As illustrated in FIG. 1, the STA 122 sleeps for a period of time and then awakes in time to hear an upcoming beacon which lists association ID (AID) values of the buffered unicast frame. A sleep cycle of a STA is based on a variable called “a listen interval” indicated in the association request frame. When the STA 122 receives the beacon, it checks whether its AID is set in the traffic indication message (TIM), and indicates that a buffered unicast frame waits. In this case, the STA 122 is aware of the buffered unicast frame. Thus, the STA 122 remains awake and sends a PS-Poll frame to the AP 112. Upon receiving the PS-Poll frame, the AP 112 transmits the buffered data to the STA 122. The STA 122 receives the buffered data and transmits an acknowledgment frame to the AP 112. After determining all the buffered data are received, the STA 122 enters the power save mode again.

As further illustrated in FIG. 1, a link 3 is established between the AP 113 and the STA 123, and the link 3 is also in the wake-up mode. The STA 123 transmits uplink data frames to the AP 113. Upon receiving the data frames transmitted by the STA 123, the AP 113 transmits an acknowledgment frame to the STA 123. As such, the data transmission between AP 113 and STA 123 is completed.

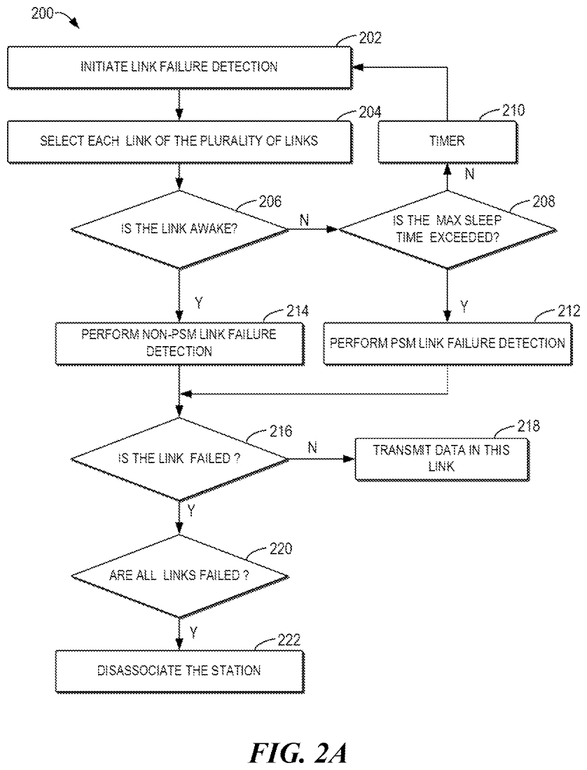

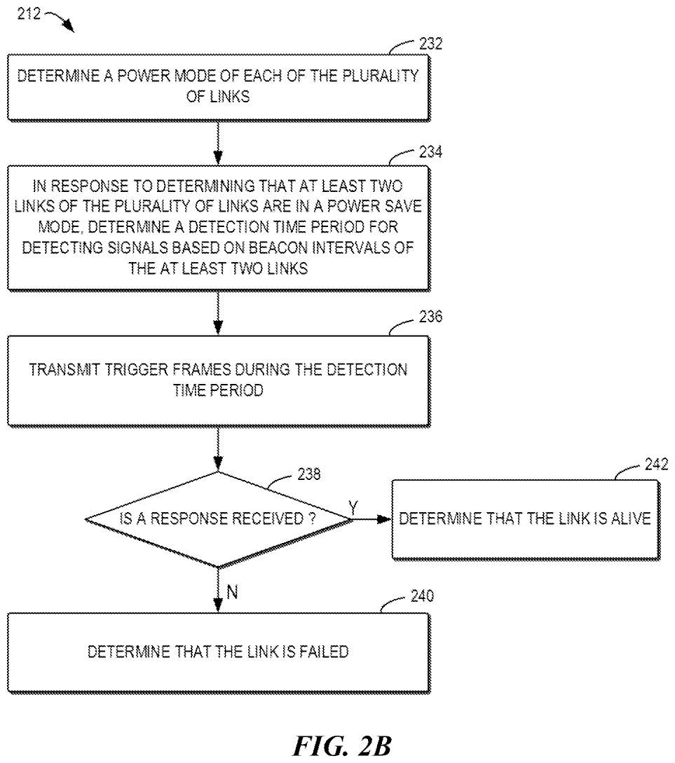

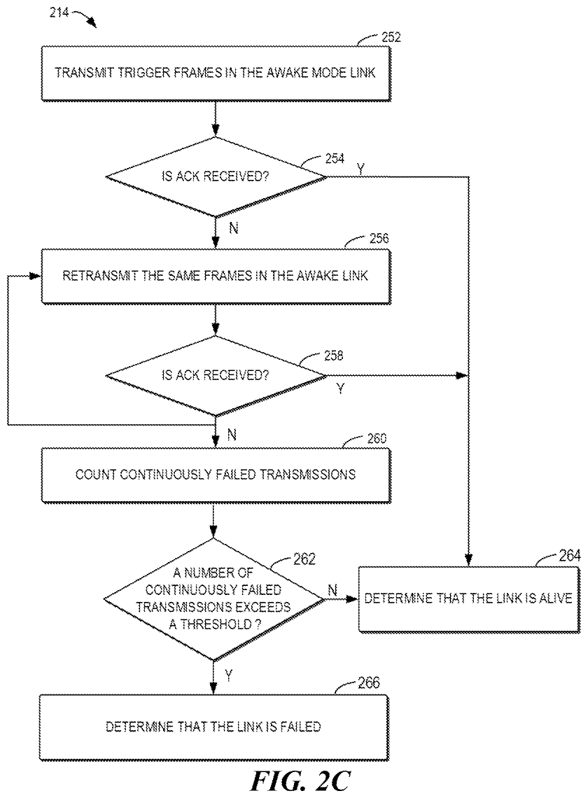

FIG. 2A illustrates a flowchart for an example method 200 of link failure detections in accordance with some example implementations of the present disclosure. For example, the method 200 may be implemented by the AP MLD 110 in FIG. 1. While only some blocks are illustrated in the method 201, the method 201 may comprise other blocks described herein. As used herein, the term “failed link” may indicate that the AP MLD fails to transmit data packets to the non-AP MLD when the link is in the non-power save mode or the AP MLD fails to receive any uplink trigger frame or acknowledgment (ACK)/block ACK for DL trigger frames from the non-AP MLD within the max listen interval time when the AP MLD has buffered data indicated in the multi-link traffic element in the beacon frame.

As illustrated in FIG. 2A, at 202, the AP MLD 110 initiates the link failure detection. For example, the link failure detection may be triggered by determining that there are data buffered for the STA MLD 120. In some alternative implementations, the link failure detection may be triggered under manual configurations or when abnormal link status is detected, or when the configuration on physical layer is changed. After the link failure detection is initiated, the AP MLD 110 will perform link failure detection for each link of the plurality of links established between the AP MLD 110 and the non-AP MLD 120.

At 204, the AP MLD 110 starts the link failure detection for each of the plurality of links. At 206, the AP MLD 110 determines whether the current link is awake. If the AP MLD 110 determines at 206 that the current link is not awake, then the method 200 proceeds to 208. At 208, the AP MLD 110 determines whether the max sleep time is exceeded by the sleep time since uplink data is transmitted in the current link. The max sleep time may be a preconfigured threshold. When an STA in the non-AP MLD 120 is in the sleep mode, the STA must wake up at the max sleep time and transmit a frame to the AP MLD 110 to indicate that the current link is not failed. When the STA has not reported to the AP MLD 110 for a time longer than the max sleep time, the STA will be identified as potentially failed and needs to be tested. Therefore, if the AP MLD 110 determines that the max sleep time has been exceeded by the sleep time of the STA, the method 200 will proceed to 212. Otherwise, the method 200 will proceed to 210. At 210, the AP MLD 110 initiates a timer to record the sleep time of the link. When the sleep time reaches the max sleep time, the method 200 will go back to 202.

At 212, the AP MLD 110 performs link failure detection for power save mode links. The link failure detection for the non-power save mode will be described later, for example, with reference to FIG. 2B.

If the AP MLD 110 determines that the current link is awake, then the method 200 proceeds to 214. At 214, the AP MLD 110 performs link failure detection for non-power save mode link. The link failure detection for the non-power save mode will be described later, for example with reference to FIG. 2C.

At 216, the AP MLD 110 determines whether the link is failed. If the AP MLD 110 determines that the link is not failed, the method 200 will proceed to 218. At 218, the AP MLD 110 will schedule and transmit data in this link. If the AP MLD 110 determines that the link is failed, the method 200 will proceed to 220. At 220, the AP MLD 110 determines whether all the links are failed. If the AP MLD 110 determines that all the links are failed, the method will proceed to 222. At 222, the AP MLD 110 disassociates the non-AP MLD 120 from the AP MLD 110. It should be appreciated that the link failure detections for different links can be simultaneously performed by corresponding APs in the AP MLD 110 or in any sequence.

With this implementation, comprehensive link failure detection for both the links in non-power save mode and the links in sleep mode are provided. In this way, the failed links of the plurality of links established between the AP MLD and the non-AP MLD can be efficiently detected.

FIG. 2B illustrates a flowchart of a method 212 in accordance with some example implementations of the present disclosure. The method 212 may be carried out by the AP MLD 110 according to the implementations described herein. While only some blocks are illustrated in the method 212, the method 212 may comprise other blocks described herein.

At 232, the AP MLD 110 determines a power mode of each of a plurality of links established between the AP MLD 110 and the non-AP MLD 120. The established links may be in a power save mode or a non-power save mode. In some example implementations, the AP MLD 110 may receive a power management indication in the links from the non-AP MLD 120 that allows the AP MLD 120 to determine the power save mode of each of the plurality of links. For example, the power management indication may be a power management field carried by any frames transmitted from the non-AP MLD 120. In this case, when the power management field has a first value “1”, it indicates that the corresponding STA in the non-AP MLD 120 is about to enter the power save mode. Therefore, when the power management indication of the link comprises a first value, the AP may determine that a link is in the power save mode. Accordingly, the AP may determine that a link is in a non-power save mode when the power management indication comprises a second value. In this way, the power mode of each link may be determined quickly.

At 234, the AP MLD 120 determines a detection time period for detecting signals based on beacon intervals of at least two links in response to determining that at least two links of the plurality of links are in a power save mode. When links are in the power save mode, the STA only wakes up at specific time points and receives beacon frames from the AP. Therefore, when the AP MLD 120 determines that some links of the plurality of links are in sleep mode, the AP MLD 120 determines a detection time period for transmitting detecting signals. In the determined detection, the STAs in the power save mode wake up at least once. The detecting signals are supposed to be received during the determined time period. In some example implementations, the detection time period may be determined based on a listen interval which may be a multiple of the beacon intervals.

In some example implementations, the AP MLD 110 may determine a maximum beacon interval among the beacon intervals of all links in the power save mode. Then, the AP MLD 110 may determine the length of the maximum beacon interval as a length of the detection time period and one of the target beacon transmission times of at least two links as a start time of the detection time period. In the case that the beacon interval is the same as the listen interval, the AP MLD 110 may determine the length of the maximum listen interval as a length of the detection time period.

In some example implementations, the target beacon transmission times in different links may be different. Any of target beacon transmission times may be selected as the start time of the detection time period. In some example implementations, the target beacon transmission time of the link with the maximum beacon interval may be selected as the start time of the detection time period. In this way, in the maximum beacon interval after the target beacon transmission time, the STAs in the power save mode links must wake up at least for one time. The length of the link failure detection can be kept to a minimum.

In some example implementations, in order to transmit detection signals in at least two links, the AP MLD 120 may determine at least one beacon interval for each link during the detection time period so that the detecting signals may be received by the STA. The AP MLD 120 transmits the detection signal according to the determined beacon interval in each of the inks.

At 236, the AP MLD 120 transmits detection signals in the power save mode links during the detection time period. In some example implementations, the detection signals may be beacon frames or data frames. At 238, the AP MLD 120 determines whether a response to each detection signal is received. If the AP MLD 110 has received a response, the method 200 will proceed to 242 and determines that the current link is alive. If the AP MLD 110 has not received any response, the method 200 will proceed to 240 and determines that the current link is failed. In some example implementations, the AP MLD 110 may determine whether all the links failed.

In some example implementations, the detection signals may comprise an indicator to indicate that data packets are buffered for the station at the AP MLD 110. In this case, the AP MLD 120 may determine that at least two links are failed links when no power save polling (PS-Poll) frame is received in each of the at least two links.

In some further example implementations, the detection signals may comprise a Quality of Service (QoS) null data frame. In this case, the AP may determine that at least two links are failed links when no acknowledgment frame is received in each of the at least two links. In this way, the link failure in the power save mode links can be detected efficiently.

FIG. 2C illustrates a flowchart of a method 214 in accordance with some example implementations of the present disclosure. The method 214 may be carried out by the AP MLD 110 according to the implementations described herein. While only some blocks are illustrated in the method 212, the method 212 may comprise other blocks described herein.

At 252, the AP MLD 110 starts to perform transmission and transmit trigger frames to the STA in the current link. For example, the AP MLD 110 may attempt to transmit the buffered data to the non-AP MLD 120. At 254, the AP MLD 110 checks whether an acknowledgment frame is received. If the AP MLD 110 has received an acknowledgment frame, the method 214 proceeds to 264. If the AP MLD 110 has not received an acknowledgment frame, the method 214 proceeds to 256.

At 256, the AP MLD 110 retransmits the same data to the STA in the current link. At 258, the AP MLD 110 checks whether an acknowledgment frame is received. If the AP MLD 110 has received an acknowledgment frame, the method 214 proceeds to 264. If the AP MLD 110 has not received an acknowledgment frame, the method 214 proceeds to 260 and goes back to 256 at the same time.

At 260, the retransmission without an acknowledgment frame will be identified as “continuously failed,” and the AP MLD 110 counts the continuously failed transmissions. At 262, the AP MLD 110 determines whether the number of continuously failed transmissions counted exceeds a predefined threshold. For example, the predefined threshold maybe 5, 8, or 12. If the AP MLD 110 determines that the number of continuously failed transmissions counted has exceeded the predefined threshold, the method 214 will proceed to 266. At 266, the AP MLD 110 determines that the current link is failed. If the AP MLD 110 determines that the number of continuously failed transmissions counted has not exceeded the predefined threshold before it receives responses from the non-AP MLD 120, the method 200 will proceed to 264. At 264, the AP MLD 110 determines that the current link is alive. In this way, the link failure in the wake-up links can be detected.

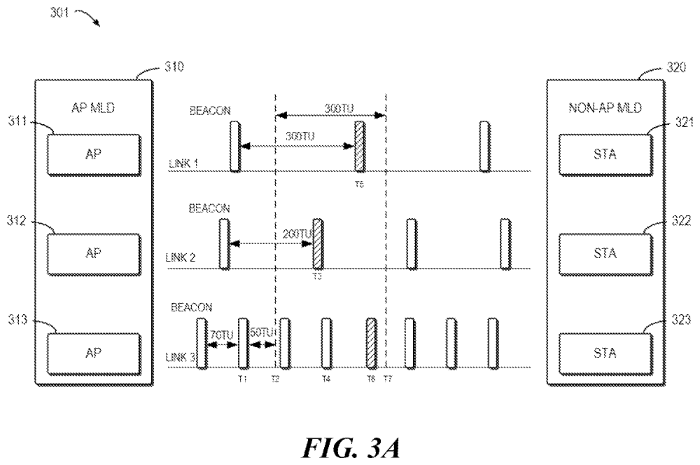

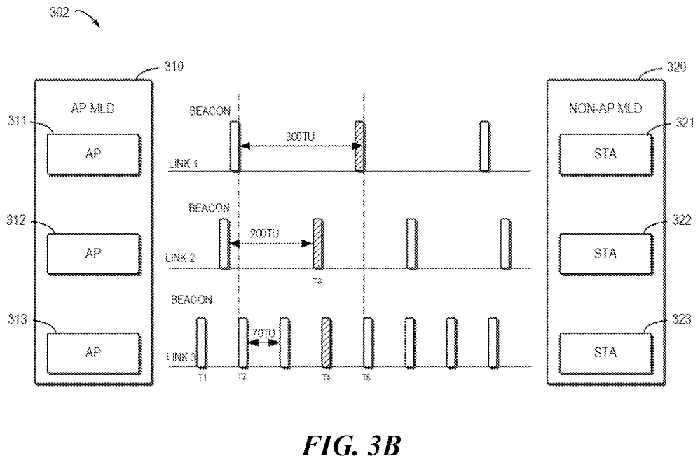

FIGS. 3A-3B illustrate example procedures for beacon transmissions in accordance with some example implementations of the present disclosure. FIG. 3A illustrates an example 301 for beacon transmissions in all the links in the power save mode. As illustrated in FIG. 3A, AP MLD 310 is associated with the non-AP MLD 320. Three links are set up between the AP MLD 310 and the non-AP MLD 320, including a link 1 between an AP 311 and a STA 321, a link 2 between an AP 312 and a STA 322, and a link 3 between an AP 313 and a STA 323. After the setup procedure, each AP in the AP MLD 110 sends a beacon frame to the corresponding STA in the non-AP MLD 120. After the AP sends the beacon frames, the AP decides the beacon interval, which is the time between two target beacon transmissions times. The AP indicates the beacon interval in the beacon frame in time units (TU), which is 1024 μs. When the AP decides the beacon interval, the STA indicates what the listen interval is in the association request frame to indicate how often the STA wakes up to receive the beacon frame when the STA is in the power save mode. The indication is in units of beacon interval. The listen interval field is in the body of the association request frame. The length of the listen interval field may be 2 octets. The value of the listen interval field may be any integer. For example, the value “2” of the listen interval field may indicate that the STA will wake up at every two beacon internals to receive beacon frame. The value “0” might be used by an STA that never enters power save mode. In some example implementations, the value may be set to “1”. After a successful multi-link setup, the AP MLD 110 may use the listen interval to determine the lifetime of frames that it buffers for the non-AP MLD 120.

In the example implementation as illustrated in FIG. 3A, the AP MLD 110 has three APs, the AP 311 operating on the link 1, the AP 312 operating on link 2, and the AP 313 operating on the link 3. The beacon intervals of link 1, link 2 and link 3 are 300 TU, 200 TU, and 70 TU, respectively. The non-AP STA 321 in the non-AP MLD 120 may send an association request frame to AP 311. According to the association request, the non-AP STA 1 may request three links to be setup (link 1 between the AP 311 and the STA 321, link 2 between the AP 312 and the STA 322, and link 3 between AP 313 and the STA 323) and set the value of listen interval field carried in the association request frame to “1”. Therefore, the listen interval requested by the non-AP MLD is 300 TU. The AP 311 may accept the three links for this multi-link setup by sending an association response frame to the STA 321. It should be appreciated that the terms “listen interval” and “beacon interval” may be used interchangeably in this implementation. Further, in order to detect the failed link more quickly, the listen interval may always be set to “1”. In some example implementations, if the listen interval field in the association request frame is not “1”, the AP MLD may reject the association request.

After a period of time, the STA 321, the STA 322 and the STA 323 enter into the power save mode for example by changing the power management field in the last frame transmitted to the AP MLD 110 to “1”. Alternatively, the STA may transmit a null data frame with a power management field of value “1”. At the time point T1, the link failure detections are triggered for example by determining that there are data buffered for the non-AP MLD 120. The AP MLD 110 determines a detection time period to perform the link failure detection for each link based on the beacon intervals of the all the asleep links. In this implementation, the detection time period is determined to be the maximum beacon interval among the three links, which is 300 TU. Further, the start time of the detection time period is selected to be 50 TU later than the time point T1. Thus, the detection time period will end at the time point T7. As illustrated in FIG. 3A, the time interval between the time point T2 and the time point T7 is 300 TU.

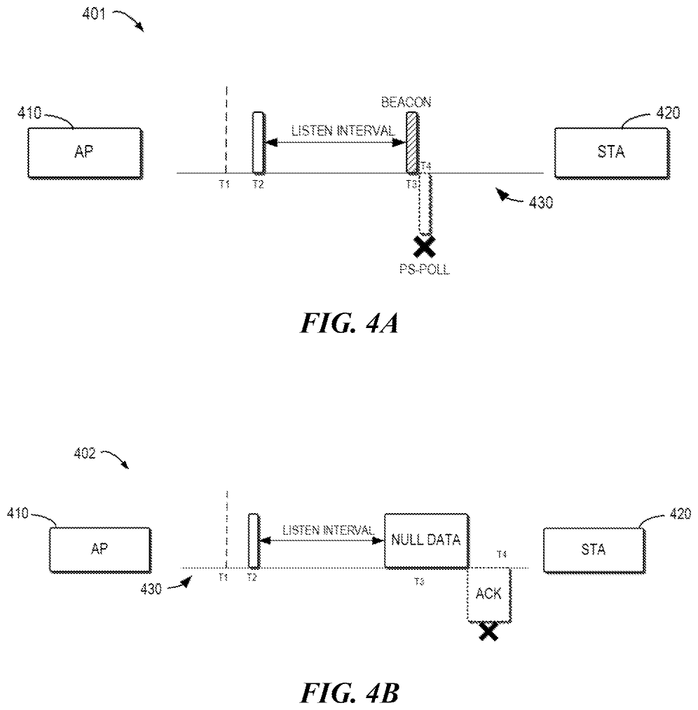

After the time point T2, each AP in the AP MLD 310 begins to indicate buffered data for the links by transmitting the indication carried in the beacon frame to the respective STA. During the detection time period, the STA 322 will wake up at the time point T3, which is the last beacon interval before the time point T7. Similarly, the STA 321 will wake up at the time point T5. The STA 323 may wake up at the time points T2, T4, and T6. If the STA 323 does not wake up at T2, the STA 323 must wake up at T4, because the non-AP MLD 310 has been informed of the buffered data from the trigger frames received in link 2 at T3. Each AP will transmit trigger frames to the corresponding STA and determine whether the link is failed based on the response from the STA. Specific detection procedures may be described, for example, with reference to FIGS. 4A and 4B.

FIG. 3B illustrates a further example procedure 302 for beacon transmissions in all the asleep links. As illustrated in FIG. 3B, the detection time period is determined to start at the time point T2, which may be also referred to as the target beacon transmission time. In some example implementations, the AP MLD 110 only determines the maximum beacon interval for all the links. The other links than the one link with the maximum beacon interval are scheduled to wake up at the end of the last beacon internal during the maximum beacon interval. In this regard, by determining the target beacon transmission time as the start time of the detection time period, the duration of the link failure detection can be kept to a minimum.

FIG. 4A illustrates an example 401 for the link failure detection for an asleep link. As illustrated in FIG. 4A, an AP 410 in an AP MLD, is associated with STA 420 in a non-AP MLD. Between the AP 410 and the STA 420, a link 430 is established. The AP 410 may be corresponding to the AP 311, as illustrated in FIG. 3A and the STA 420 may correspond to the STA 321, as illustrated in FIG. 3A. At the time point T1, the link failure detection is initiated. The AP 410 determines that the sleep time of the link has exceeded the max sleep time, then selects the target beacon transmission time of the time point T2 as the start time of the detection time period and the beacon interval as the length of the detection time period. Accordingly, the STA 420 is scheduled to wake up at the time point T3 to hear beacon frame from the AP 410. At the time point T3, the AP 410 transmits the beacon frame indicating the buffered data for the STA 420. However, at the time point T4, the AP 410 has not received a PS-Poll frame as a response to the beacon frame. Thus, the AP 410 determines that the link 430 is failed.

FIG. 4B illustrates a further example 402 for a link failure detection for an asleep link. The difference between the implementation as illustrated in FIG. 4A and FIG. 4B is that instead of a beacon frame, the AP 410 transmits a null data frame as a detection trigger frame to the STA 420. However, the AP 410 has not received an acknowledgement (ACK) frame at the time point T4 and thus determines that the link 430 is failed.

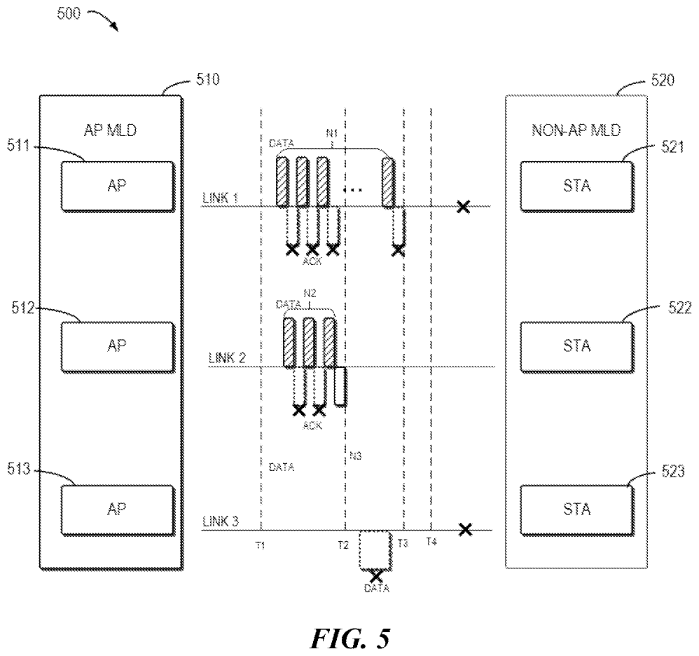

FIG. 5 illustrates an example 500 for the link failure detection for multiple awake links in accordance with some example implementations of the present disclosure. As illustrated in FIG. 5, three links have been established between the AP MLD 510 and the non-AP MLD 520, including a link 1 established between an AP 511 and an STA 521, a link 2 established between an AP 512 and an STA 522, a link 3 established between an AP 513 and an STA 523. In this implementation, the link 1, the link 2, and the link 3 are all in the non-power save mode. At the time point T1, the link failure detections are initiated. Each AP will start to transmit the buffered data or trigger frames (for example, QoS null data frames) to the corresponding STA.

For the link 1, when the AP 511 transmits the data frames to the STA 521 for the first time, if the AP 511 has not received an acknowledgment frame from the STA 521, the AP 511 transmits the same data frame once again. During the link failure detection, the AP 511 will record the number of continuously failed transmissions. As illustrated in FIG. 5, at the time point T3, the data frames have been continuously transmitted for N1 times, but no acknowledgment frame has been received. At this time, the AP 511 determines that the number has already exceeded a threshold (for example N1−1). On this basis, the AP 511 determines that link 1 is failed.

For the link 2, the AP 512 also transmits data frames to the STA 522. When the data frames are transmitted after N2 times, the AP 512 receives an acknowledgment frame from the STA 2 521 at the time point T2. Since N2 is less than the threshold number for continuously failed transmission, the AP 512 determines that the link 2 is alive.

For the link 3, a different detection scheme is applied. Instead of performing transmission in the link, the AP 513 records a time period from which the last frame is received from the STA 523. As illustrated in FIG. 5, the STA 523 has not transmitted any frames to the AP 513. At the time point T4, the recorded time period has exceeded a time threshold. On this basis, the AP 3 determines that link 3 is failed. In this way, all the failed awake links can be detected efficiently.

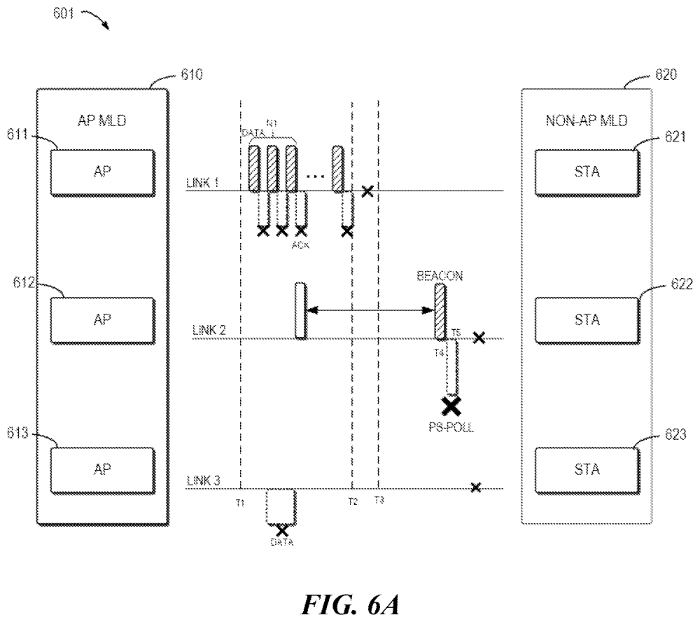

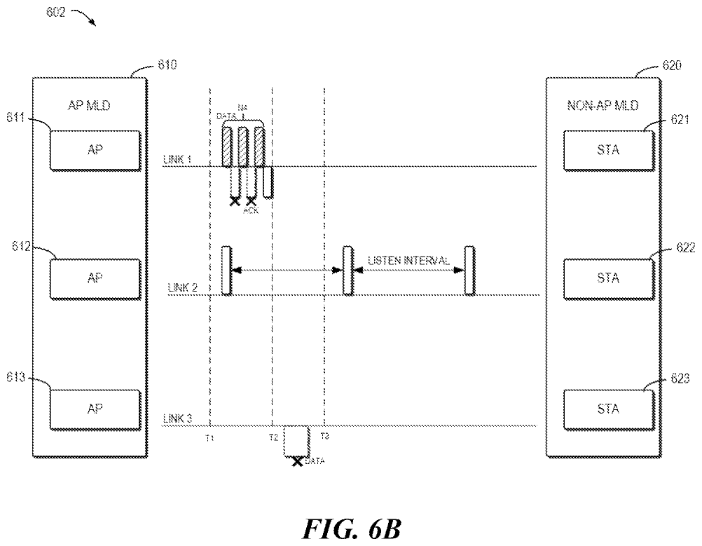

FIG. 6A illustrates an example 601 for link failure detections for awake and asleep links in accordance with some example implementations of the present disclosure. As illustrated in FIG. 6A, three links have been established between the AP MLD 610 and the non-AP MLD 620, including a link 1 established between an AP 611 and an STA 621, a link 2 established between an AP 612 and an STA 622, a link 3 established between an AP 613 and an STA 623. The link 1 and the link 3 are in the non-power save mode, and the link 2 is in the sleep mode. At the time point T1, the link failure detections are initiated. The AP MLD 610 performs the link failure detections similar to that illustrated in FIG. 5 for the link 1 and the link 3. At the time point T2, with the link failure detection, the AP 611 determines that the link 1 is failed based on a determination that the number of the continuously failed transmissions N1 has exceeded the number threshold. The AP 613 determines that the Link 3 failed at the time point T3, based on a determination that the time period without transmitting frames has exceeded the time threshold.

For link 2, the AP 612 performs the link failure detections similar to that illustrated in FIGS. 4A and 4B. The AP 612 transmits a beacon frame indicating buffered data for the STA 622 at the time point T4. However, the AP 612 has not received a PS-Poll frame from the STA 622 at the time point T5. On this basis, the AP 612 determines that link 2 is failed.

As illustrated in FIG. 6A, due to the detection time period, the link detection for the link 2 may be performed later than those performed for the awake link 1 and the awake link 3. In some example implementations, the AP MLD 610 may perform the link failure detection after all the awake links are determined to be failed which is illustrated in the FIG. 6B.

FIG. 6B illustrates a further example 602 for link failure detections for awake and asleep links in accordance with some example implementations of the present disclosure. At the time point T1, the AP 611 and the AP 613 start to perform the link failure detections after the link failure detections are initiated. Differ from the implementation as illustrated in FIG. 6A, the AP 612 does not perform the link failure detection. Instead, the AP 612 may continue to monitor the buffered data for the STA 622. Once the AP 612 has buffered data for the STA 622, the AP 612 performs the link failure detection.

As illustrated in FIG. 6B, at the time point T2, with the link failure detection, the AP 611 determines that the link 1 is alive based on receiving an acknowledgment frame from STA 621, and the number of continuously failed transmissions N4 is less than the number threshold. Therefore, data frames can be transmitted in the link 1, and there is no need to perform the link failure detection for link 2.

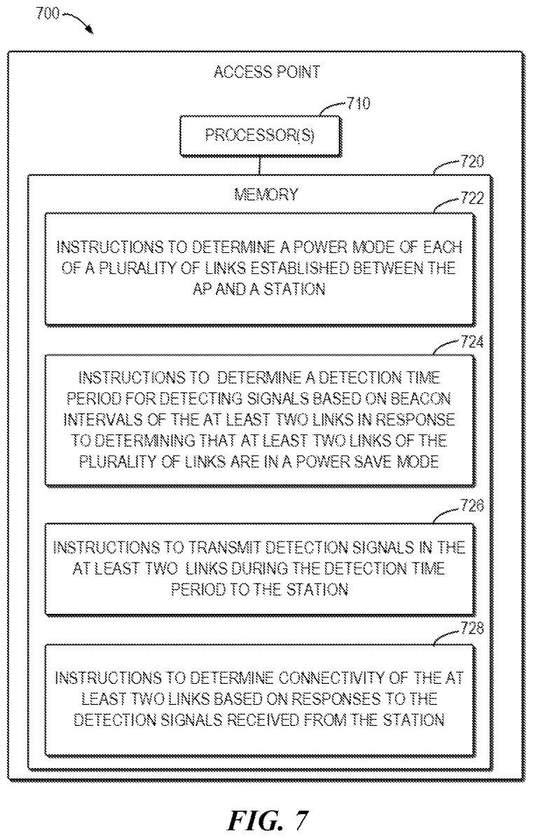

FIG. 7 illustrates a block diagram of an example AP MLD 700 in accordance with some example implementations of the present disclosure. The AP MLD 700 comprises at least one processor 710 and a memory 720 coupled to at least one processor 710. The memory 720 stores instructions to cause at least one processor 710 to implement actions.

As illustrated in FIG. 7, the memory 720 stores instructions 722 to determine a power mode of each of a plurality of links established between an AP MLD and a non-AP MLD. The memory 720 further stores instructions 724 to determine a detection time period for detecting signals based on beacon intervals of the at least two links when the AP MLD determines that at least two links of the plurality of links are in a power save mode. The memory 720 further stores instructions 726 to transmit detection signals in at least two links during the detection time period. The memory 720 further stores instructions 728 to determine the connectivity of at least two links based on responses to the detection signals received from the station.

In some example implementations, when executed for example by the AP MLD 310, the instructions 724 causes the AP MLD 310 to determine a maximum beacon interval among the asleep links and further select a length of the maximum beacon interval as a length of the detection time period. In addition, the AP MLD 310 may be further caused to select a target beacon transmission time as a start time of the detection time period.

In some example implementations, when executed for example by the AP MLD 310, the instructions 726 cause the AP MLD 310 to determine the beacon interval for every links during the detection time period. The STA 321, 322, and 323 will wake up at the respective beacon intervals during the detection time period and receives frames from the AP 311, 312, 313. The AP MLD 310 may be further caused to transmit the detection signals according to the determined beacon interval in each of the links.

In some example implementations, the detection signals may comprise an indication that data packets are buffered for the AP MLD 310. In this case, when executed by the AP MLD 310, the instructions 728 cause the AP MLD 310 to check whether a power save polling (PS-Poll) frame is received. If no PS-Poll frame is received, the AP MLD 310 is further caused to determine that the link is failed.

In some alternative implementations, the detection signals comprise a QoS null data frame. In this case, when executed by the AP MLD 310, the instructions 728 to causes the AP MLD 310 to check whether an acknowledgment frame is received. If no PS-Poll frame is received, the AP MLD 310 is further caused to determine that the link is failed.

In some example implementations, when executed by the AP MLD 310, the instructions 722 cause the AP MLD 310 to determine the power mode of a link based on the received power management indication. If the received power management indication has a first value, the AP MLD 310 is caused to determine that the link is in the power save mode. If the received power management indication has a second value, the AP MLD 310 is caused to determine that the link is in the non-power save mode.

In some example implementations, the memory 720 further stores instructions, which when executed by the AP MLD 510, cause the AP MLD 510 to perform transmissions in the non-power save mode. The AP MLD 510 is further caused to count a number of continuously failed transmissions. When the number of continuously failed transmissions exceeds a predefined threshold, the AP MLD 510 is further caused to determine that is at least one link is failed.

In some example implementations, the memory 720 further stores instructions, which when executed by the AP MLD 110, cause the AP MLD 110 to determine that the station has lost connectivity to the AP MLD when all of the plurality of links are failed. Then, the AP MLD 110 is caused to disassociate the non-AP MLD 120 from the AP MLD 110. Alternatively, if the AP MLD 110 determines that one link is not failed, the AP MLD 110 is caused to transmit the data in this frame.

The present disclosure also provides at least one computer program product tangibly stored on a non-transitory computer-readable storage medium. The computer program product includes program codes or instructions which can be executed to carry out the method as described above with reference to FIGS. 2A-2C.

While the above discussion used a Wi-Fi communication standard as an illustrative example, in other implementations a wide variety of communication standards and, more generally, wireless communication technologies may be used. Furthermore, while some of the operations in the foregoing implementations were implemented in hardware or software, in general, the operations in the preceding implementations can be implemented in a wide variety of configurations and architectures. Therefore, some or all of the operations in the foregoing implementations may be performed in hardware, software, or both.

It should be noted that specific terms disclosed in the present disclosure are proposed for convenience of description and a better understanding of example implementations of the present disclosure, and the use of these specific terms may be changed to another format within the technical scope or spirit of the present disclosure.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a computer-readable medium may be any tangible medium that may contain or store a program for use by or in connection with an instruction execution system, apparatus, or device. The computer-readable medium may be a computer-readable signal medium or a computer-readable storage medium. A computer-readable medium may include but is not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order illustrated or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is illustrated by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
determining, by an access point (AP), a power mode of each of a plurality of links established between the AP and a station;
in response to determining that at least two links of the plurality of links are in a power save mode, determining, by the AP, a detection time period for detecting signals based on beacon intervals of the at least two links;
transmitting, by the AP to the station, detection signals in the at least two links during the detection time period; and
determining, by the AP, connectivity of the at least two links based on responses to the detection signals received from the station.

2. The method of claim 1, wherein determining the detection time period comprises:
determining, by the AP, a maximum beacon interval among the beacon intervals of the at least two links;
determining, by the AP, a length of the maximum beacon interval as a length of the detection time period; and
determining, by the AP, one of target beacon transmission times of the at least two links as a start time of the detection time period.

3. The method of claim 1, wherein transmitting detection signals in the at least two links comprises:
determining, by the AP, at least one beacon interval for each of the at least two links during the detection time period; and
transmitting, by the AP, a detection signal according to the at least one beacon interval in each of the at least two links.

4. The method of claim 1, wherein the detection signals comprise an indication that data packets are buffered for the station at the AP, and wherein determining the connectivity of the at least two links comprises:
in response to determining that no power save polling (PS-Poll) frame is received in each of the at least two links, determining that the at least two links are failed links.

5. The method of claim 1, wherein the detection signals comprise a Quality of Service (QoS) null data frame, and wherein determining the connectivity of the at least two links comprises:
in response to determining that no acknowledgement frame is received in each of the at least two links, determining that the at least two links are failed links.

6. The method of claim 1, wherein determining the power mode of each of the plurality of links comprises:
receiving, by the AP from the station, a power management indication in each of the plurality of links; and
in response to determining that a power management indication of a first link comprises a first value, determining that the first link is in the power save mode.

7. The method of claim 6, wherein determining the power save mode of each of the plurality of links further comprises:
in response to determining that a power management indication of a second link comprises a second value, determining that the second link is in a non-power save mode.

8. The method of claim 1, further comprising:
in response to determining that a third link of the plurality of links is in a non-power save mode, performing transmissions in the at least one link;
counting a number of continuously failed transmissions;
in response to determining that the number of the continuously failed transmissions exceeds a predefined threshold, determining that the third link is failed.

9. The method of claim 8, further comprising:
in response to determining that the at least one further link and the at least two links are failed, determining, by the AP, that the station has lost connectivity to AP; and
disassociating, by the AP, the station from the AP.

10. The method of claim 8, further comprising:
determining that one link of the plurality of links is not failed; and
transmitting, by the AP to the station, buffered data in the one link.

11. An access point (AP) comprising:
at least one processor; and
a memory coupled to the at least one processor, the memory storing instructions to cause the at least one processor to:
determine a power save mode of each of a plurality of links established between the AP and a station;
in response to determining that at least two links of the plurality of links are in a power save mode, determine a detection time period for detecting signals based on beacon intervals of the at least two links;
transmit detection signals in the at least two links during the detection time period to the station; and
determine connectivity of the at least two links based on responses to the detection signals received from the station.

12. The AP of claim 11, wherein the instructions to determine the detection time period further comprise instructions to cause the at least one processor to:
determine a maximum beacon interval among the beacon intervals of the at least two links;
determine a length of the maximum beacon interval as a length of the detection time period; and
determine one of target beacon transmission times of the at least two links as a start time of the detection time period.

13. The AP of claim 11, wherein the instructions to transmit detection signals in the at least two links comprise instructions to cause the at least one processor to:
determine at least one beacon interval for each of the at least two links during the detection time period; and
transmit the detection signal according to the at least one beacon interval in each of the at least two links.

14. The AP of claim 11, wherein the detection signals comprise an indication that data packets are buffered for the station at the AP, and the instructions to determine the connectivity of the at least two links further comprise instructions to cause the at least one processor to:
in response to determining that no power save polling (PS-Poll) frame is received in each of the at least two links, determine that the at least two links are failed links.

15. The AP of claim 11, wherein the detection signals comprise a Quality of Service (QoS) null data frame, and the instructions to determine the connectivity of the at least two links further comprise instructions to cause the at least one processor to:
in response to determining that no acknowledgment frame is received in each of the at least two links, determine that the at least two links are failed links.

16. The AP of claim 11, wherein the instructions to determine the power mode of each of the plurality of links further comprise instructions to cause the at least one processor to:
receive, by the AP from the station, a power management indication in each of the plurality of links; and
in response to determining that a power management indication of a first link comprises a first value, determine that the first link is in the power save mode.

17. The AP of claim 16, wherein the instructions to determining the power save mode of each of the plurality of links further comprise further instructions to cause the at least one processor to:
in response to determining that a power management indication of a second link comprises a second value, determine that the second link is in an non-power save mode.

18. The AP of claim 11, wherein the memory further stores instructions to cause the at least one processor to:
in response to determining that a third link of the plurality of links is in an non-power save mode, perform transmissions in the at least one link;
count a number of continuously failed transmissions;
in response to determining that the number of the continuously failed transmissions exceeds a predefined threshold, determine that the third link is failed.

19. The AP of claim 18, wherein the memory further stores instructions to cause the at least one processor to:
in response to determining that the at least one further link and the at least two links are failed, determine, by the AP, that the station has lost connectivity to AP; and
disassociate, by the AP, the station from the AP.

20. A non-transitory computer-readable medium comprising instructions stored thereon which, when executed by an access point (AP), cause the apparatus to:
determine a power save mode of each of a plurality of links established between the AP and a station;
in response to determining that at least two links of the plurality of links are in a power save mode, determine a detection time period for detecting signals based on beacon intervals of the at least two links;
transmit detection signals in the at least two links during the detection time period to the station; and
determine connectivity of the at least two links based on responses to the detection signals received from the station.
